(19) United States
(12) Patent Application Publication
(10) Pub. No.: US 2022/0267102 A1
(43) Pub. Date: Aug. 25, 2022

(54) CONVEYANCE SYSTEM, CONVEYANCE METHOD, AND CONVEYANCE PROGRAM

(71) Applicant: TOYOTA JIDOSHA KABUSHIKI KAISHA, Toyota-shi (JP)

(72) Inventor: Yutaro ISHIDA, Toyota-shi (JP)

(21) Appl. No.: 17/649,237

(22) Filed: Jan. 28, 2022

(30) Foreign Application Priority Data
Feb. 22, 2021 (JP) 2021-026114

(51) Int. Cl. B65G 43/10

(52) U.S. Cl. CPC B65G 43/10

(57) ABSTRACT

A conveyance system includes a conveyance robot that has a sensor that detects information on an obstacle around the robot, and moves while holding a carried item, according to a movement route based on the information on the obstacle detected by the sensor. The conveyance system includes a blind area calculating unit that calculates a blind area of the sensor generated by the carried item, an information obtaining unit that obtains information on an obstacle in the blind area of the sensor calculated by the blind area calculating unit, and a route planning unit that plans the movement route of the conveyance robot, based on the information on the obstacle in the blind area obtained by the information obtaining unit.

### CROSS-REFERENCE TO RELATED APPLICATION

This application claims priority to Japanese Patent Application No. 2021-026114 filed on Feb. 22, 2021, incorporated herein by reference in its entirety.

### BACKGROUND

### 1. Technical Field

The disclosure relates to a conveyance system that conveys a carried item, a conveying method, and a conveyance program.

### 2. Description of Related Art

A conveyance robot is known which has a sensor that detects information on an obstacle around the robot, and moves while holding a carried item, according to a movement route set based on the information on the obstacle detected by the sensor (see, for example, Japanese Patent No. 6247796).

### SUMMARY

When the conveyance robot moves while holding the carried item, the carried item may obstruct vision of the sensor, and a blind spot of the sensor may be generated. Due to the presence of the blind spot, the sensor may not be able to detect an obstacle that lies in the blind spot, and the conveyance robot may collide with the obstacle.

The disclosure provides a conveyance system, conveying method, and conveyance program, which can prevent a conveyance robot from colliding with an obstacle that lies in a blind spot of a sensor.

A first aspect of the disclosure is concerned with a conveyance system including a conveyance robot that has a sensor that detects information on an obstacle around the conveyance robot, and is configured to move while holding a carried item, according to a movement route based on the information on the obstacle detected by the sensor. The conveyance system includes a blind area calculating unit that calculates a blind area of the sensor generated by the carried item, an information obtaining unit that obtains information on an obstacle in the blind area of the sensor calculated by the blind area calculating unit, and a route planning unit that plans the movement route of the conveyance robot, based on the information on the obstacle in the blind area obtained by the information obtaining unit. In the first aspect, the conveyance system may further include a storage unit that stores the information on the obstacle detected by the sensor, and the information obtaining unit may obtain information on an obstacle in an area corresponding to the blind area of the sensor calculated by the blind area calculating unit, from the storage unit, as the information on the obstacle in the blind area of the sensor. In the first aspect, the information obtaining unit may obtain at least one of information on an obstacle detected by a sensor of the conveyance robot other than the sensor of which the blind area is generated, information on an obstacle detected by a sensor of another conveyance robot, and information on an obstacle detected by a sensor provided on a route of the conveyance robot, as the information on the obstacle in the blind area of the sensor. In the first aspect, the conveyance robot may have a holding device that holds the carried item, and the blind area calculating unit may calculate the blind area of the sensor generated when the holding device holds the carried item. In this case, the holding device may hold the carried item, such that the blind area of the sensor is reduced. In the first aspect, the conveyance system may further include a position detecting unit that detects positional information of the carried item and the conveyance robot, and the blind area calculating unit may calculate the blind area of the sensor, based on the positional information of the carried item and the conveyance robot detected by the position detecting unit, and dimensional information of the carried item. A second aspect of the disclosure is concerned with a conveying method of moving a conveyance robot having a sensor that detects information on an obstacle around the conveyance robot, according to a movement route based on the information on the obstacle detected by the sensor, such that the conveyance robot holds a carried item. The conveying method includes a step of calculating a blind area of the sensor generated by the carried item, a step of obtaining information on an obstacle in the calculated blind area of the sensor, and a step of planning the movement route of the conveyance robot, based on the obtained information on the obstacle in the blind area. A third aspect of the disclosure is concerned with a conveyance program for moving a conveyance robot having a sensor that detects information on an obstacle around the conveyance robot, according to a movement route based on the information on the obstacle detected by the sensor, such that the conveyance robot holds a carried item. The conveyance program causes a computer to execute the steps of: calculating a blind area of the sensor generated by the carried item, obtaining information on an obstacle in the calculated blind area of the sensor, and planning the movement route of the conveyance robot, based on the obtained information on the obstacle in the blind area.

According to the disclosure, the conveyance system, conveying method, and conveyance program, which can prevent the conveyance robot from colliding with an obstacle that lies in a blind spot of the sensor, can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view of a conveyance system according to a first embodiment;

FIG. 2 is a block diagram of the conveyance system according to the embodiment;

FIG. 3 is a block diagram schematically showing the system configuration of a computing unit according to the embodiment;

FIG. 4 is a view showing blind areas of distance sensors;

FIG. 5 is a flowchart illustrating the flow of a conveying method according to the embodiment;

FIG. 6 is a block diagram schematically showing the system configuration of a conveyance robot according to a second embodiment; and

FIG. 7 is a view showing the configuration of a conveyance system that does not include a host management device.

### DETAILED DESCRIPTION OF EMBODIMENTS

While this disclosure will be described through some embodiments of the disclosure, the disclosure as defined in any of the appended claims is not limited to the embodiments described below. For explicit explanation, the following description and the drawings are subjected to omission or simplification as appropriate. In each drawing, the same reference signs are assigned to the same elements, and repeated description of the elements is omitted as needed.

### First Embodiment

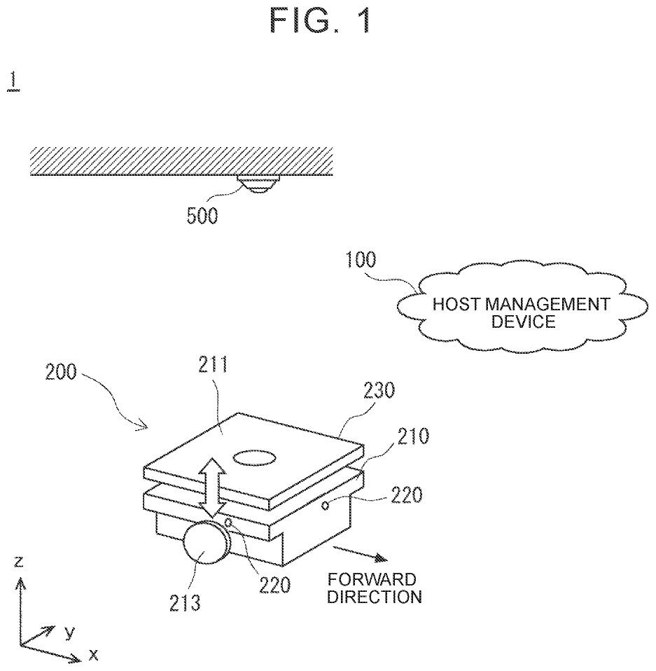

FIG. 1 is a schematic view of a conveyance system according to a first embodiment. Referring to FIG. 1, the conveyance system 1 according to the embodiment will be described. In the conveyance system 1, a conveyance robot 200 that autonomously moves in a predetermined region conveys a carried item that is to be conveyed.

The conveyance system 1 shown in FIG. 1 is one example of the conveyance system. For example, the conveyance system 1 can convey a carrier shelf on which dishes, drugs, medical appliances, etc. are placed, to a preset location, in a facility, such as a hospital. The conveyance system 1 has, as main constituent elements, a host management device 100, conveyance robot 200, and environment camera 500.

The host management device 100 grasps conditions in the facility, using the environment camera 500, etc., and controls the conveyance robot 200, to convey the carried item. The host management device 100 may be provided in the facility in which the conveyance robot 200 is in operation, or may be installed in a location away from the facility. The host management device 100 has a communication function, and is able to communicate with equipment, such as the conveyance robot 200 and the environment camera 500, in the facility. The environment camera 500 is provided on a movement route of the conveyance robot 200, for example.

The conveyance robot 200 is configured as an autonomous mobile robot that moves on a floor of a hospital, for example. The conveyance robot 200 can hold a carried item, such as a carrier shelf, and convey it from a given location (a point of departure) to another location (a destination).

The configuration of the conveyance robot 200 will be described in detail. The conveyance robot 200 shown in FIG. 1 is one example of the autonomous mobile robot, and may take another form.

The conveyance robot 200 according to this embodiment has a robot main body 210 in the shape of a generally rectangular parallelepiped, distance sensors 220 attached to the robot main body 210, an elevating unit 230 provided on the top face of the robot main body 210, and wheels 213 attached to the right and left side faces of the robot main body 210.

A wheel driving unit that drives the wheels 213 is provided in the robot main body 210. While a pair of wheels 213 is attached to the right and left side faces of the robot main body 210, the arrangement of the wheels is not limited to this. For example, two pairs of wheels may be attached to the right and left side faces of the robot main body 210, or a pair of wheels may be attached to the right and left side faces of the robot main body 210, and one auxiliary wheel may be attached to the robot main body 210.

The distance sensor 220 is one specific example of the sensor. For example, the distance sensor 220 is in the form of a laser sensor, camera, or the like. The distance sensors 220 are provided on the right and left side faces, front and rear faces, top face, etc. of the robot main body 210. The distance sensors 220 obtain distance information of an obstacle or obstacles and a carried item present around the conveyance robot 200. In this connection, the number of the distance sensors 220 provided on the robot main body 210 may be selected as desired, and the location at which each of the distance sensors 220 is provided may be selected as desired provided that it can detect an obstacle, etc.

The elevating unit 230 generally refers to an arrangement that goes up and down relative to the robot main body 210, and consists of a plate 211 on which the carried item is placed and held in position, an elevating mechanism that raises and lowers the plate 211, etc. The elevating unit 230 is one specific example of the holding device.

The conveyance robot 200 gets into under the carried item, based on the distance information of the carried item detected by the distance sensors 220, and route plan information that will be described later. Then, after getting into under the carried item, the conveyance robot 200 lifts and holds the carried item by means of the elevating unit 230, and conveys the carried item by moving in a condition where the item is lifted up.

While the conveyance robot 200 is configured to lift the carried item by means of the elevating unit 230, and moves while holding the item in the condition where it is lifted up, as described above, the configuration of the conveyance robot 200 is not limited to this. The conveyance robot 200 may not have the elevating unit 230. In this case, an operator, or the like, may place the carried item on the plate 211 of the robot main body 210, for example.

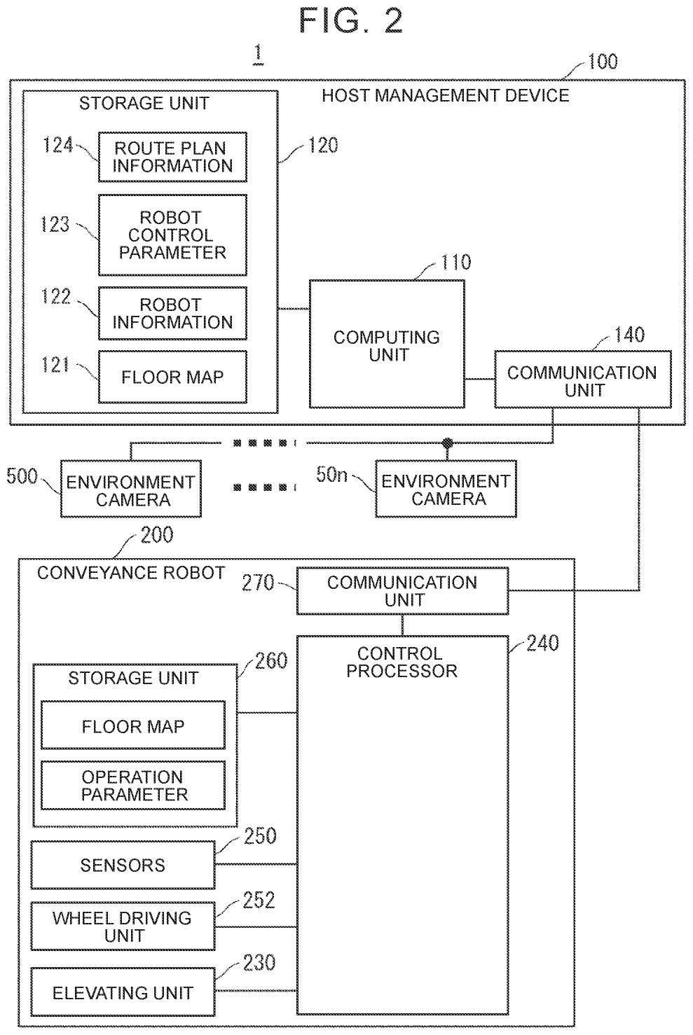

Next, the system configuration of the conveyance system 1 will be described in detail with reference to FIG. 2. FIG. 2 is a block diagram of the conveyance system 1 according to the embodiment. The conveyance system 1 has the host management device 100, conveyance robot 200, and environment cameras 501 to 50n.

Initially, the host management device 100 will be described in detail. The host management device 100 has a computing unit 110, storage unit 120, and communication unit 140. The storage unit 120 stores a floor map 121, robot information 122, robot control parameters 123, and route plan information 124.

The computing unit 110 is a processor, such as a central processing unit (CPU), that can execute programs, for example, and is able to perform processing as described later, according to a conveyance program.

The computing unit 110 gives an operation command to the conveyance robot 200, according to a preset schedule. At this time, the computing unit 110 issues the operation command to the conveyance robot 200, via the communication unit 140.

When issuing the operation command, the computing unit 110 grasps the point of departure and destination of the conveyance robot 200, referring to the floor map 121, and plans a movement route of the conveyance robot 200, referring to the route plan information 124. The computing unit 110 sends the planned movement route of the conveyance robot 200 to the conveyance robot 200, via the communication unit 140. Also, the computing unit 110 determines operating conditions of the conveyance robot 200, referring to the robot information 122 and the robot control parameters 123, and sends the operating conditions thus determined, to the conveyance robot 200, via the communication unit 140.

The communication unit 140 is an interface that is communicably connected to the conveyance robot 200, and consists of a circuit, etc., that modulates or demodulates signals transmitted via an antenna, for example. The communication unit 140 is connected to the computing unit 110, and supplies a given signal received from the conveyance robot 200 via wireless communications, to the computing unit 110. The communication unit 140 sends a given signal received from the computing unit 110, to the conveyance robot 200. The communication unit 140 is also configured to be able to wirelessly communicate with the environment cameras 501 to 50n.

Next, the system configuration of the conveyance robot 200 will be described in detail. The conveyance robot 200 has the elevating unit 230, a control processor 240, sensors 250, a wheel driving unit 252, storage unit 260, and communication unit 270.

The control processor 240, which is an information processing unit having a processor, such as a CPU, obtains information from respective components of the conveyance robot 200, and sends commands to the respective components. The control processor 240 controls operation of the wheel driving unit 252 and the elevating unit 230.

The sensors 250 generally refer to various sensors of the conveyance robot 200. The sensors 250 include the above-mentioned distance sensors 220, an attitude sensor, rotary encoder, and so forth. The sensors 250 are connected to the control processor 240, and supply detected signals to the control processor 240.

The wheel driving unit 252 includes a motor driver, etc. for driving motors of the wheels 213. The elevating unit 230 includes a motor driver, etc. for driving a motor of the elevating mechanism. The wheel driving unit 252 and the elevating unit 230 are connected to the control processor 240, and are driven in response to commands from the control processor 240.

The control processor 240 controls movement of the conveyance robot 200, based on the movement route transmitted from the computing unit 110, and the distance information of any obstacle detected by the distance sensors 220. For example, the control processor 240 controls the wheel driving unit 252, so that the conveyance robot 200 moves according to the movement route transmitted from the computing unit 110, while avoiding any obstacle detected by the distance sensors 220, based on the distance information of the obstacle. In this manner, the conveyance robot 200 can autonomously move from a set point of departure to a set destination, while avoiding obstacles.

The storage unit 260 includes a non-volatile memory, and stores a floor map and operation parameters. The floor map is a database needed for autonomous movement of the conveyance robot 200, and includes information that is identical with at least a part of the floor map stored in the storage unit 120 of the host management device 100. The floor map may include positional information of an obstacle(s) and a carried item.

When the conveyance robot 200 lifts a carried item by means of the elevating unit 230, and moves in the condition where the item is lifted up, as described above, the carried item may obstruct vision of any of the distance sensors 220, and a blind spot of the distance sensor 220 may be generated.

Conventionally, due to the blind spot of the distance sensor, the distance sensor may not be able to detect an obstacle that lies in the blind spot, and the conveyance robot may collide with the obstacle.

On the other hand, the conveyance system 1 according to this embodiment calculates a blind area of the distance sensor 220 generated by the carried item, obtains information on an obstacle in the calculated blind area of the distance sensor 220, and plans the movement route of the conveyance robot 200, based on the obtained information on the obstacle in the blind area. In this manner, the conveyance robot 200 can be prevented from colliding with the obstacle that lies in the blind spot of the distance sensor 220.

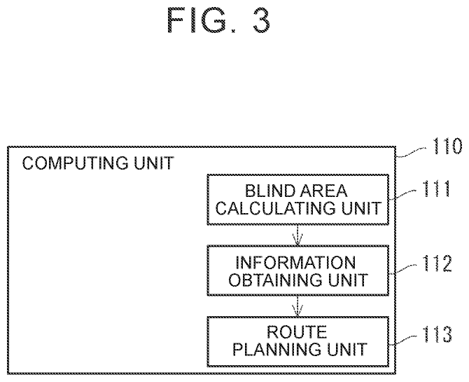

FIG. 3 is a block diagram schematically showing the system configuration of the computing unit 110 according to the embodiment. The computing unit 110 according to the embodiment includes a blind area calculating unit 111 that calculates a blind area of the distance sensor 220 concerned, an information obtaining unit 112 that obtains information on an obstacle in the blind area of the distance sensor 220, and a route planning unit 113 that plans a movement route of the conveyance robot 200.

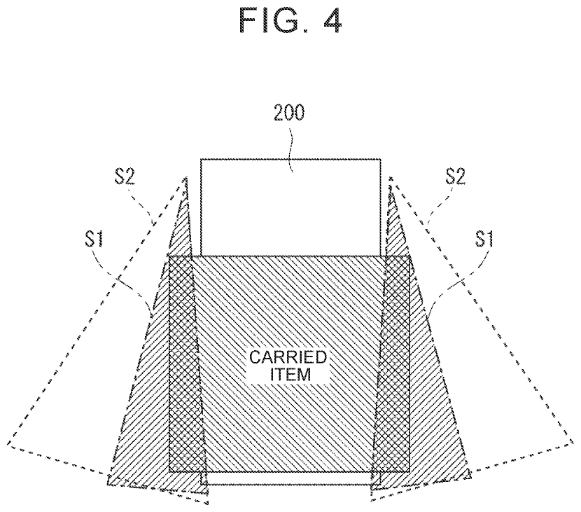

The blind area calculating unit 111 calculates the blind area of the distance sensor 220 generated by the carried item. For example, as shown in FIG. 4, the blind area calculating unit 111 calculates a blind area S1 in which the carried item obstructs vision of the distance sensor 220, and no obstacle can be detected by the distance sensor 220, within a detection area S2 of the distance sensor 220.

The blind area calculating unit 111 calculates the blind area of the distance sensor 220, based on information on the positions of the carried item and the conveyance robot 200, and information on the dimensions of the carried item. For example, the carried item may be provided with a marker or markers. The positional information of the conveyance robot 200 includes information on the installation positions of the distance sensors 220. The blind area calculating unit 111 calculates the relative position relationship between the conveyance robot 200 and the carried item, based on the marker of the carried item and an image of the conveyance robot 200 captured by the environment camera 500, etc. The blind area calculating unit 111 is one specific example of the position detecting unit.

The dimensional information of the carried item includes the vertical dimension, lateral dimension, and height of the carried item, for example. The dimensional information of the carried item may be set in advance in the blind area calculating unit 111. The blind area calculating unit 111 may obtain the dimensional information of the carried item from the robot information 122 of the storage unit 120, for example. The blind area calculating unit 111 may calculate the dimensions of the carried item, based on an image of the carried item captured by the environment camera 500, a camera of the conveyance robot 200, or the like.

The blind area calculating unit 111 calculates the blind area of the distance sensor 220, based on the calculated relative position relationship between the conveyance robot 200 and the carried item, and the dimensional information of the carried item. As described above, the blind area calculating unit 111 can easily calculate the blind area of the distance sensor 220 generated by the carried item, with high accuracy. The blind area calculating unit 111 outputs the calculated blind area of the distance sensor 220, to the information obtaining unit 112.

The information obtaining unit 112 obtains information on an obstacle in the blind area of the distance sensor 220 calculated by the blind area calculating unit 111.

The distance sensor 220 may send the distance information of the detected obstacle to the storage unit 120 of the host management device 100 or the storage unit 260 of the conveyance robot 200, so that the information is stored in the storage unit 120 or storage unit 260.

The information obtaining unit 112 obtains distance information of an obstacle in an area corresponding to the blind area of the distance sensor 220 calculated by the blind area calculating unit 111, from the storage unit 120, 260, as the information on the obstacle in the blind area of the distance sensor 220. Thus, it is possible to easily complement the current obstacle information in the blind area, by effectively using the past obstacle information of the distance sensor 220 that currently generates the blind area.

The information obtaining unit 112 may obtain distance information of an obstacle detected by a distance sensor 220 other than the distance sensor 220 that generates the blind area, as the information on the obstacle in the blind area of the distance sensor 220.

The conveyance robot 200 may be provided with a plurality of distance sensors 220 on the right side face, left side face, front face, rear face, top face, etc. of the robot main body 210. For example, the information obtaining unit 112 may obtain distance information of an obstacle detected by the distance sensor 220 on the top face of the robot main body 210, as the information on the obstacle in the blind area of the distance sensor 220 on the right side face of the robot main body 210. Thus, it is possible to easily complement the obstacle information in the blind area, by effectively using the obstacle information provided by another distance sensor 220 that generates no blind area.

The information obtaining unit 112 may obtain information on an obstacle detected by a distance sensor 220 of another conveyance robot 200, or information on an obstacle detected by the environment camera 500, as the information on the obstacle in the blind area of the distance sensor 220. Thus, it is possible to easily complement the obstacle information in the blind area, by effectively using the obstacle information provided by the distance sensor 220 of another conveyance robot 200, or the environment camera 500.

In this connection, the information obtaining unit 112 may obtain information as an arbitrary combination of the information on an obstacle detected by the distance sensor 220 of the conveyance robot 200 other than the distance sensor 220 that generates the blind area, information on an obstacle detected by the distance sensor 220 of another conveyance robot 200, and information on an obstacle detected by the environment camera 500, as the information on the obstacle in the blind area of the distance sensor 220.

The information obtaining unit 112 outputs the obtained information on the obstacle in the blind area of the distance sensor 220, to the route planning unit 113.

The route planning unit 113 plans the movement route of the conveyance robot 200, based on the information on the obstacle in the blind area obtained by the information obtaining unit 112. For example, the route planning unit 113 plans the movement route for avoiding the obstacle in the blind area obtained by the information obtaining unit 112. The route planning unit 113 sends the movement route of the conveyance robot 200 planned as described above, to the conveyance robot 200, via the communication unit 140. The conveyance robot 200 can move while avoiding the obstacle in the blind area of the distance sensor 220, according to the movement route planned by the route planning unit 113.

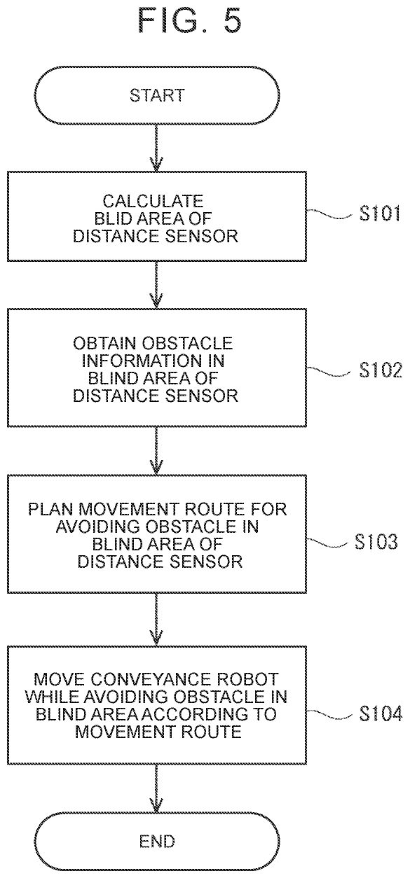

Next, a conveying method according to this embodiment will be described. FIG. 5 is a flowchart illustrating the flow of the conveying method according to this embodiment.

The blind area calculating unit 111 of the computing unit 110 calculates a blind area of the distance sensor 220 generated by the carried item (step S101). The blind area calculating unit 111 outputs the calculated blind area of the distance sensor 220, to the information obtaining unit 112.

The information obtaining unit 112 obtains information on an obstacle that lies in the blind area of the distance sensor 220 calculated by the blind area calculating unit 111 (step S102). The information obtaining unit 112 outputs the obtained information on the obstacle in the blind area of the distance sensor 220, to the route planning unit 113.

The route planning unit 113 plans a movement route that avoids the obstacle in the blind area obtained by the information obtaining unit 112 (step S103). The route planning unit 113 sends the movement route of the conveyance robot 200 planned as described above, to the conveyance robot 200, via the communication unit 140.

The conveyance robot 200 moves while avoiding the obstacle in the blind area of the distance sensor 220, according to the movement route planned by the route planning unit 113 (step S104).

As described above, the conveyance system 1 according to this embodiment includes the blind area calculating unit 111 that calculates the blind area of the distance sensor 220 generated by the carried item, the information obtaining unit 112 that obtains the information on the obstacle in the blind area of the distance sensor 220 calculated by the blind area calculating unit 111, and the route planning unit 113 that plans the movement route of the conveyance robot 200, based on the information on the obstacle in the blind area obtained by the information obtaining unit 112. Thus, the conveyance robot 200 can be prevented from colliding with any obstacle that lies in the blind spot of the distance sensor 220.

### Second Embodiment

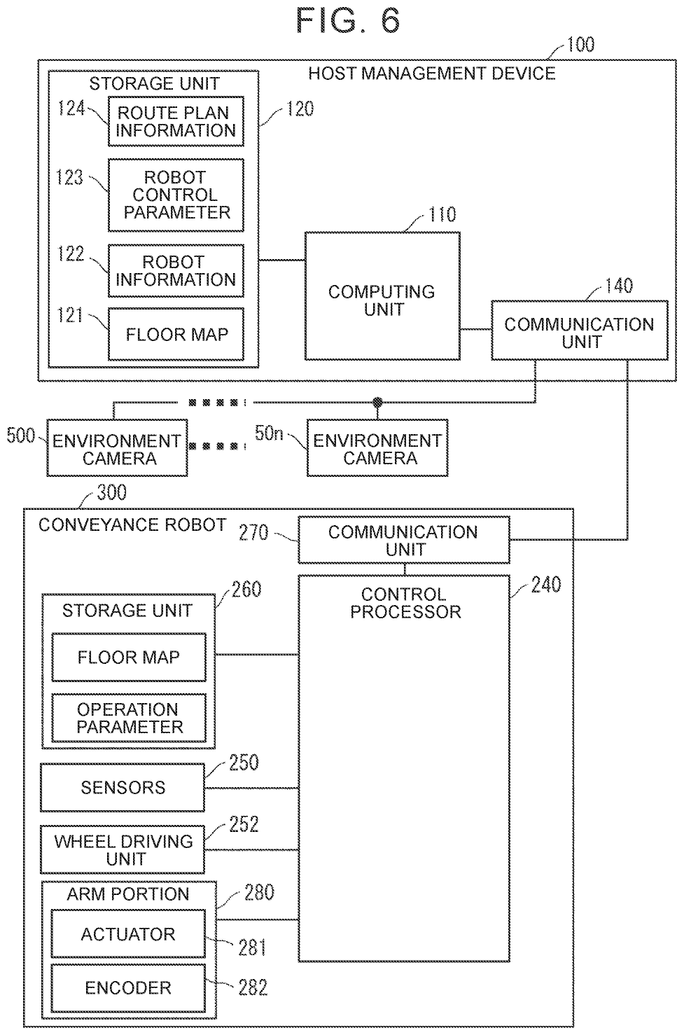

FIG. 6 is a block diagram schematically showing the system configuration of a conveyance robot according to a second embodiment. The conveyance robot 300 may have an arm portion 280 that grasps a carried item. The arm portion 280 is one specific example of the holding device. In this case, the conveyance robot 300 conveys the carried item, in a condition where the carried item is held by the arm portion 280.

The blind area calculating unit 111 of the computing unit 110 of the host management device 100 calculates a blind area of the distance sensor 220 generated when the arm portion 280 holds the carried item. The control processor 240 of the conveyance robot 300 controls operation of the arm portion 280, by sending a control signal to the arm portion 280.

The arm portion 280 is in the form of a multi-joint arm having two or more link portions, two or more joint portions that rotatably couple the respective link portions, and a hand portion that grasps the carried item. Each of the joint portions and hand portion is provided with an actuator 281, such as a servo motor, for driving the joint portion or hand portion, encoder 282, and so forth. The actuator 281 of each of the joint portions and hand portion is driven according to a control signal transmitted from the control processor 240. For example, the control processor 240 performs feedback control or robust control on the actuator 281 of each of the joint portions and hand portion.

When the arm portion 280 holds the carried item, the control processor 240 may control operation of the arm portion 280, so as to reduce the blind area of the distance sensor 220. Thus, it is possible to further reduce the blind area of the distance sensor 220, so that the conveyance robot 300 can move more safely while avoiding collision between the carried item and an obstacle.

For example, the control processor 240 operates the hand portion of the arm portion 280 in preset two or more directions, in a condition where the hand portion of the arm portion 280 grasps the carried item. The blind area calculating unit 111 calculates a blind area of the distance sensor 220 generated by the carried item, at a position of each of the two or more directions in which the hand portion is operated.

The control processor 240 controls the arm portion 280 so as to hold the carried item, at a position at which the blind area of the distance sensor 220 calculated by the blind area calculating unit 111 is minimized. The conveyance robot 300 conveys the carried item, in a condition where the carried item is held at the position by the arm portion 280.

While some embodiments of the disclosure have been described, these embodiments are merely exemplary, and are not intended to limit the scope of the disclosure. The novel embodiments can be carried out in various other forms, and may be subjected to various omissions, replacements, and changes, without departing from the principle of the disclosure. The embodiments and their modifications are included in the scope or principle of the disclosure, and included in the disclosure described in the appended claims, and equivalents thereof.

For example, in the conveyance system 1 according to the embodiment, the functions provided in the host management device 100 and the conveyance robot 200 may be installed on either of the devices depending on the use. The functions of the computing unit 110, storage unit 120, etc. of the host management device 100 may be installed on the conveyance robot 200 side.

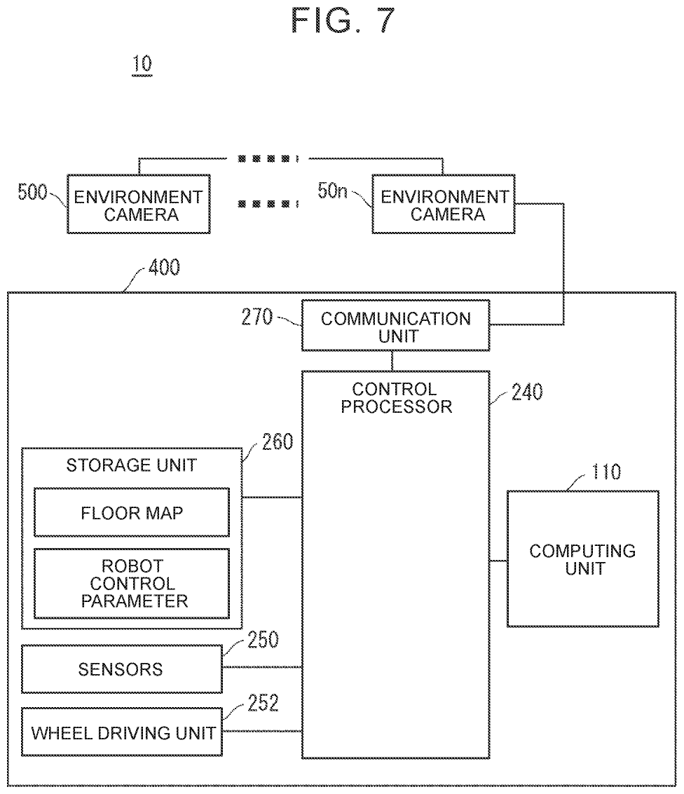

For example, a conveyance system 10 may not include the host management device 100, as shown in FIG. 7. A conveyance robot 400 further includes the computing unit 110, in addition to the configuration of the first embodiment. Further, the conveyance system 10 may consist solely of the conveyance robot 400, without including the environment cameras 500.

According to the disclosure, it is possible to carry out the process shown in FIG. 5, by causing a processor to execute a computer program, for example.

The program may be stored by use of a non-transitory computer readable medium of various types, and supplied to a computer. The non-transitory computer readable medium may be selected from various types of tangible storage media. Examples of the non-transitory computer readable medium include a magnetic recording medium (e.g., a flexible disk, magnetic tape, hard disk drive), magneto-optical recording medium (e.g., a magneto-optical disk), CD-ROM (read-only memory), CD-R, CD-R/W, and semiconductor memory (e.g., a mask ROM, PROM (Programmable ROM), EPROM (Erasable PROM), flash ROM, RAM (random access memory)).

The program may be supplied to a computer via a transitory computer readable medium of various types. Examples of the transitory computer readable medium include an electric signal, optical signal, and electromagnetic wave. The transitory computer readable medium may supply the program to the computer, via a wire communication path, such as an electric wire, and an optical fiber, or a wireless communication path.

Each unit of the computing unit 110 of the conveyance system 1 according to the above embodiment is not only realized by a program, but may also be partially or entirely realized by a dedicated hardware, such as an ASIC (Application Specific Integrated Circuit), or FPGA (Field-Programmable Gate Array).

What is claimed is:

1. A conveyance system including a conveyance robot that has a sensor that detects information on an obstacle around the conveyance robot, and is configured to move while holding a carried item, according to a movement route based on the information on the obstacle detected by the sensor, comprising:
a blind area calculating unit that calculates a blind area of the sensor generated by the carried item;
an information obtaining unit that obtains information on an obstacle in the blind area of the sensor calculated by the blind area calculating unit; and
a route planning unit that plans the movement route of the conveyance robot, based on the information on the obstacle in the blind area obtained by the information obtaining unit.

2. The conveyance system according to claim 1, further comprising a storage unit that stores the information on the obstacle detected by the sensor,
wherein the information obtaining unit obtains information on an obstacle in an area corresponding to the blind area of the sensor calculated by the blind area calculating unit, from the storage unit, as the information on the obstacle in the blind area of the sensor.

3. The conveyance system according to claim 1, wherein the information obtaining unit obtains at least one of information on an obstacle detected by a sensor of the conveyance robot other than the sensor of which the blind area is generated, information on an obstacle detected by a sensor of another conveyance robot, and information on an obstacle detected by a sensor provided on a route of the conveyance robot, as the information on the obstacle in the blind area of the sensor.

4. The conveyance system according to claim 1, wherein:
the conveyance robot has a holding device that holds the carried item; and
the blind area calculating unit calculates the blind area of the sensor generated when the holding device holds the carried item.

5. The conveyance system according to claim 4, wherein the holding device holds the carried item, such that the blind area of the sensor is reduced.

6. The conveyance system according to claim 1, further comprising a position detecting unit that detects positional information of the carried item and the conveyance robot,
wherein the blind area calculating unit calculates the blind area of the sensor, based on the positional information of the carried item and the conveyance robot detected by the position detecting unit, and dimensional information of the carried item.

7. A conveying method of moving a conveyance robot having a sensor that detects information on an obstacle around the conveyance robot, according to a movement route based on the information on the obstacle detected by the sensor, such that the conveyance robot holds a carried item, comprising:
calculating a blind area of the sensor generated by the carried item;
obtaining information on an obstacle in the calculated blind area of the sensor; and
planning the movement route of the conveyance robot, based on the obtained information on the obstacle in the blind area.

8. A conveyance program for moving a conveyance robot having a sensor that detects information on an obstacle around the conveyance robot, according to a movement route based on the information on the obstacle detected by the sensor, such that the conveyance robot holds a carried item, the conveyance program causing a computer to execute the steps of:
calculating a blind area of the sensor generated by the carried item;
obtaining information on an obstacle in the calculated blind area of the sensor; and
planning the movement route of the conveyance robot, based on the obtained information on the obstacle in the blind area.
